(19) United States
(12) Patent Application Publication
(10) Pub. No.: US 2014/0270269 A1
(43) Pub. Date: Sep. 18, 2014

(54) LOUDSPEAKER DEVICE

(71) Applicant: Hugh C. Hsieh, Chiayi City (TW)

(72) Inventor: Hugh C. Hsieh, Chiayi City (TW)

(21) Appl. No.: 13/846,834

(22) Filed: Mar. 18, 2013

(51) Int. Cl. H04R 1/00

(52) U.S. Cl. CPC H04R 1/00
USPC 381/152

(57) ABSTRACT

A loudspeaker device includes a rear frame member defining a receiving space, a magnetic assembly, and a sound producing assembly. The magnetic assembly includes a yoke, a magnet, a magnetically permeable plate that cooperates with the yoke to form an air gap, and a connecting tube that passes through and fastens together the yoke, the magnet and the magnetically permeable plate, that is heat conductive, and that defines an axially extending air passageway in fluid communication with the receiving space. The sound producing assembly includes a vibrating member that cooperates with the magnetically permeable plate to define a chamber in fluid communication with the air passageway and the air gap.

### BACKGROUND OF THE INVENTION

1. Field of the Invention

The present invention relates to a loudspeaker device, more particularly to a loudspeaker device suitable for an alarm or a car siren.

2. Description of the Related Art

Referring to FIGS. 1 and 2, a conventional loudspeaker 1 used for an alarm (not shown) includes a rear frame member 11 having a front open side, a yoke 12 disposed in the rear frame member 11 and having a front open side, a magnet 13 disposed in the yoke 12, a magnetically permeable plate 14 disposed in the yoke 12 in front of the magnet 13, a heat dissipation member 15 disposed in front of the magnetically permeable plate 14, a washer 16 adhered to a front edge of the rear frame member 11, a vibrating member 17 that is disposed in front of and spaced apart from the heat dissipation member 15 and that has a peripheral portion adhered to the washer 16, a voice coil 18 connected to a rear portion of the vibrating member 17, a front cover member 19 mounted to and disposed in front of the rear frame member 11, and an equalizer 10 that is fixedly mounted on a rear side of the front cover member 19 and that is disposed in front of and spaced apart from the vibrating member 17.

The magnetically permeable plate 14 cooperates with the yoke 12 to form an air gap 121, and the voice coil 18 is disposed in the air gap 121. The magnetically permeable plate 14 is for guiding a magnetic flux produced by the magnet 13, thereby forming a magnetic field in the air gap 121. The magnet 13 and the yoke 12 form an inner space 122 therebetween, and the yoke 12 and the rear frame member 11 form an outer space 123 therebetween. The yoke 12 includes a base wall 124 and a surrounding wall 125 that extends forwardly from a periphery of the base wall 124. The surrounding wall 125 is formed with a plurality of through holes 126 extending radially outward from the inner space 122 to the outer space 123, respectively.

The voice coil 18 generates a plurality of directional lines of electromagnetic force in response to flow of electric current therethrough. The lines of electromagnetic force and the magnetic field in the air gap 121 interact with each other. The interaction produces a force that causes the voice coil 18 and the vibrating member 17 to move back and forth, thereby producing sound waves.

The voice coil 18 is made of a conductive material and has an electrical resistance. As a consequence, when electricity is supplied to the voice coil 18, the electric current flowing therethrough results in the generation of heat that requires heat dissipation.

By virtue of thermal convection, the problem of temperature rise in the loudspeaker 1 may be alleviated. Specifically, the vibration of the vibrating member 17 causes air to flow between the inner space 122 and the outer space 123 via the through holes 126. The heat produced by the voice coil 18 may be carried by the air flow and ultimately leaves the loudspeaker 1, thereby achieving heat dissipation.

However, a longitudinal length of each through hole 126 is perpendicular to the vibrating direction of the vibrating member 17, such that the air flowing through the through holes 126 may result in a turbulent flow which may reduce the efficiency of heat dissipation. Moreover, the through holes 126 are drilled through the curved surrounding wall 125, which may increase the difficulty of manufacture. Furthermore, the washer 16 and the vibrating member 17 are fixedly attached to the front edge of the rear frame member 11 by adhesive, which may create various disadvantages. For example, it is difficult to tightly and smoothly adhere the washer 16, the vibrating member 17 and the rear frame member 11 to one another. Moreover, when the vibrating member 17 is damaged, both of the vibrating member 17 and the washer 16 should be replaced.

### SUMMARY OF THE INVENTION

Therefore, an object of the present invention is to provide a loudspeaker device that may alleviate the above drawbacks of the prior art.

Accordingly, a loudspeaker device of the present invention comprises a frame assembly, a magnetic assembly and a sound producing assembly.

The frame assembly includes a rear frame member that defines a receiving space. The receiving space opens forwardly.

The magnetic assembly includes a yoke, a magnet, a magnetically permeable plate and a connecting tube. The yoke is disposed in the receiving space of the rear frame member, and includes a base wall and a surrounding wall that extends forwardly from a periphery of the base wall. The magnet is disposed in the yoke in front of the base wall. The magnetically permeable plate is disposed in the yoke in front of the magnet, and cooperates with the surrounding wall to form an air gap. The connecting tube passes through and fastens together the base wall, the magnet and the magnetically permeable plate. The connecting tube is made of a heat conductive material, and defines an axially extending air passageway that is in fluid communication with the receiving space.

The sound producing assembly includes a vibrating member and a voice coil. The vibrating member has a diaphragm part disposed in front of the magnetically permeable plate, and a coil bobbin that is connected to the diaphragm part and that extends into the air gap. The diaphragm part and the magnetically permeable plate define a chamber in fluid communication with the air passageway and the air gap. The voice coil is connected to the coil bobbin.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled sectional view of a conventional loudspeaker;

FIG. 2 is an exploded sectional view of the conventional loudspeaker;

FIG. 3 is an exploded perspective view of a preferred embodiment according to the present invention;

FIG. 4 is an exploded sectional view of the preferred embodiment of a loudspeaker device according to the present invention; and

FIG. 5 is an assembled sectional view of the preferred embodiment according to the present invention.

### DETAILED DESCRIPTION OF THE PREFERRED EMBODIMENT

Referring to FIGS. 3, 4 and 5, a preferred embodiment of a loudspeaker device according to the present invention is suitable for an alarm or a car siren (not shown), and is capable of converting an electrical signal into acoustical energy in the form of sound waves. The loudspeaker device includes a frame assembly 100, a magnetic assembly 3, a sound producing assembly 4, and an enclosure 7. The frame assembly 100 includes a rear frame member 2, a front cover member 5, and a plurality of fastener units 6.

The rear frame member 2 is made of a heat-dissipating material (e.g., an aluminum alloy material) and includes a base portion 21. The base portion 21 includes an end wall 211 and a peripheral wall 212 extending forwardly from the end wall 211 and cooperating therewith so as to form a receiving space 214. The rear frame member 2 has a front end surface that defines an opening 213 for access into the receiving space 214. The end wall 211 has an inner surface 215 confronting the receiving space 214. The inner surface 215 is formed with a first groove 216 and a plurality of second grooves 217 that extend from the first groove 216 toward the peripheral wall 212 and that are in fluid communication with the receiving space 214. The peripheral wall 212 is formed with a plurality of screw holes 218 that are spaced apart from each other and that extend rearwardly from a front end surface of the peripheral wall 212. The rear frame member 2 further includes an outer frame portion 22 extending outwardly from the peripheral wall 212 of the base portion 21, thereby enlarging the area for dissipating heat. In this preferred embodiment, the frame assembly 100 further includes a waterproofing ring 23.

The magnetic assembly 3 includes a yoke 31, a magnet 32, a magnetically permeable plate 33 and a connecting tube 34. The yoke 31 is disposed in the receiving space 214 of the rear frame member 2. The yoke 31 includes a base wall 311 and a surrounding wall 312 extending forwardly from a periphery of the base wall 311. The base wall 311 is formed with a first hole 313 in the middle thereof. The magnet 32 is disposed in the yoke 31 in front of the base wall 311 and is spaced apart from the surrounding wall 312. The magnet 32 is formed with a second hole 321 that is aligned and in fluid communication with the first hole 313. The magnetically permeable plate 33 is disposed in the yoke 31 in front of the magnet 32. The magnetically permeable plate 33 is spaced apart from the surrounding wall 312 and cooperates with the surrounding wall 312 to form an air gap 35 therebetween. The magnetically permeable plate 33 is formed with a third hole 331 that is aligned and in fluid communication with the first and second holes 313, 321. The magnetically permeable plate 33 is for guiding a magnetic flux produced by the magnet 32, thereby forming a magnetic field in the air gap 35. The connecting tube 34 in this preferred embodiment is made of a heat-conductive copper. The connecting tube 34 passes through the first, second and third holes 313, 321, 331 and rivets together the yoke 31, the magnet 32 and the magnetically permeable plate 33. The connecting tube 34 defines an axially extending air passageway 341 that is in fluid communication with the receiving space 214 and that is registered with the first groove 216. Preferably, the magnetic assembly 3 further includes a filter screen 36 that is disposed at a rear side of the base wall 311 and that is registered with the connecting tube 34. The filter screen 36 is for covering the air passageway 341 to prevent entry of unwanted dust particles into the air passageway 341.

The sound producing assembly 4 includes a washer 41, an insulator ring 42, a vibrating member 43 and a voice coil 44. The washer 41 is ring-shaped and is disposed in front of the front end surface of the peripheral wall 212 of the rear frame member 2. The insulator ring 42 is disposed correspondingly in front of the washer 41. The vibrating member 43 is disposed in front of the insulator ring 42 and the opening 213 of the receiving space 214. The voice coil 44 is connected to the vibrating member 43 and is electrically connected to a power supply (not shown).

The washer 41 is formed with a plurality of first perforations 411 respectively corresponding to the screw holes 218 of the peripheral wall 212. The insulator ring 42 is formed of an electrically-insulating material, such as Bakelite, and is formed with a plurality of second perforations 421 respectively corresponding to the first perforations 411 of the washer 41. The vibrating member 43 has a diaphragm part 431, a suspension part 432 and a coil bobbin 433. The diaphragm part 431 is disposed in front of the magnetically permeable plate 33 and is formed with a convex shape. The suspension part 432 extends outwardly and radially from a periphery of the diaphragm part 431 and is disposed forwardly of the insulator ring 42. The coil bobbin 433 is connected to the diaphragm part 431 and extends into the air gap 35. The diaphragm part 431 and the magnetically permeable plate 33 define a chamber 45 in fluid communication with the air passageway 341 and the air gap 35. The suspension part 432 is formed with a plurality of notches 434 respectively corresponding to the second perforations 421 of the insulator ring 42. The voice coil 44 is connected to the coil bobbin 433 and is for actuating vibration of the vibrating member 43 to produce the sound waves.

The front cover member 5 is disposed in front of the vibrating member 43 of the sound producing assembly 4 and is connected to the base portion 21 of the rear frame member 2. The front cover member 5 includes a cover body 51 connected to the rear frame member 2 and formed with a sound hole 511 that extends in a front-to-rear direction, and an equalizer 52 connected to the cover body 51 and disposed adjacent to the diaphragm part 431 and the sound hole 511. The cover body 51 of the front cover member 5 cooperates with the base portion 21 of the rear frame member 2 to tightly press the waterproofing ring 23 so as to prevent entry of water into the receiving space 214 as well as possible water damage of the magnetic assembly 3 and the sound producing assembly 4. The cover body 51 is formed with a plurality of through holes 512 respectively corresponding to the screw holes 218 of the base portion 21. The equalizer 52 is disposed adjacent to the diaphragm part 431 of the vibrating member 43, and has a curved shape. However, since the feature of the present invention does not reside in the specific construction of the equalizer 52, a detailed description of the equalizer 52 is omitted herein for the sake of brevity.

The fastener units 6 fasten separably the front cover member 5, the suspension part 432 of the vibrating member 43, the insulator ring 42, the washer 41 and the rear frame member 2. Each fastener unit 6 includes a screw 61 and a waterproof gasket 62. Each screw 61 passes through the respective one of the through holes 512 of the front cover member 5, the respective one of the notches 434 of the suspension part 432 of the vibrating member 43, the respective one of the second perforations 421 of the insulator ring 42, and the respective one of the first perforations 411 of the washer 41, and engages threadedly the respective one of the screw holes 218 of the base portion 21 of the rear frame member 2. The waterproof gasket 62 is sleeved on the screw 61 and is retained between the screw 61 and the front cover member 5.

The enclosure 7 is disposed to cover the front cover member 5 and is connected separably to the outer frame portion 22 of the rear frame member 2.

When the electrical input signal is applied to the voice coil 44, a plurality of directional lines of electromagnetic force are generated so as to form an electromagnetic field. The direction of the lines of electromagnetic force may change in response to the alternating current flowing in the voice coil 44. As a result, the changing electromagnetic field interacts with the magnetic field produced by the magnet 32 in the air gap 35 to generate an attraction force and/or a repulsion force therebetween. The attraction and/or repulsion force causes the vibrating member 43 to move back and forth, thereby producing the sound waves.

The vibration of the vibrating member 43 produces air flows through the air gap 35 and the air passageway 341 to intake cool air and exhaust heated air into and out of the loudspeaker device. Specifically, when the vibrating member 43 moves rearwardly, the heated air in the chamber 45 is forced to move rearwardly to the first groove 216 via the air passageway 341 of the connecting tube 34. The heated air then flows in the plurality of second grooves 217 and moves radially and outwardly from the first groove 216 to the receiving space 214 through the plurality of second grooves 217. Finally, the heated air is dissipated via the base portion 21 and the outer frame portion 22. On the other hand, when the vibrating member 43 moves forwardly, the cool air in the receiving space 214 is guided to move inwardly from the receiving space 214 to the first groove 216 via the plurality of the second grooves 217. The cool air then passes through the air passageway 341 of the connecting tube 34 and into the chamber 45. Therefore, heat exchange between the interior and the exterior of the loudspeaker device may be achieved.

Moreover, since the connecting tube 34 is made of a heat-conductive copper and rivets together the yoke 31, the magnet 32 and the magnetically permeable plate 33, the heat of the yoke 31, the magnet 32 and the magnetically permeable plate 33 may be directly conducted to the connecting tube 34 and be dissipated via the air flow in the air passageway 341, thereby maintaining a desired temperature within the magnetic assembly 3 and the sound producing assembly 4 as well as prolonging the service life of the loudspeaker device. Furthermore, in the present invention, the loudspeaker device further includes the outer frame portion 22 that extends outwardly from the base portion 21 and that is exposed to the air outside the loudspeaker device. For example, when a car (not shown) is moving at a fast speed, the outer frame portion 22 may be exposed to air against the car so as to immediately exhaust heated air and intake cool air, thereby hastening the process of heat dissipation and improving the efficiency of heat dissipation.

To conclude, the loudspeaker device according to the present invention may efficiently dissipate heat for the following reasons. First of all, the connecting tube 34 is heat-conductive and rivets together the yoke 31, the magnet 32 and the magnetically permeable plate 33 so that the heat may be directly conducted to the connecting tube 34 and ultimately be guided away from the loudspeaker device. Secondly, the longitudinal length of the air passageway 341 of the connecting tube 34 is parallel to the vibrating direction of the vibrating member 43, such that, in combination with the configures of the first groove 216 and the second grooves 217 of the base portion 21, the possibility of turbulent flow occurring inside the loudspeaker device is greatly decreased. Therefore, the efficiency of heat dissipation of the loudspeaker device according to the present invention is significantly improved.

Moreover, the first hole 313 of the yoke 31, the second hole 321 of the magnet 32 and the third hole 331 of the magnetically permeable plate 33 are formed through flat surfaces instead of curved surfaces, which simplifies the manufacture of the loudspeaker device.

Furthermore, the fastener units 6 of the loudspeaker device according to the present invention fasten separably the front cover member 5, the vibrating member 43, the insulator ring 42, the washer 41, and the rear frame member 2. Therefore, it is easy to tightly assemble and smoothly disassemble the loudspeaker device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A loudspeaker device comprising:
a frame assembly including a rear frame member that defines a receiving space, said receiving space opening forwardly;
a magnetic assembly including
a yoke disposed in said receiving space of said rear frame member and including a base wall and a surrounding wall that extends forwardly from a periphery of said base wall,
a magnet disposed in said yoke in front of said base wall,
a magnetically permeable plate disposed in said yoke in front of said magnet, said magnetically permeable plate cooperating with said surrounding wall to form an air gap, and
a connecting tube passing through and fastening together said base wall, said magnet and said magnetically permeable plate, said connecting tube defining an axially extending air passageway that is in fluid communication with said receiving space and being made of a heat conductive material; and
a sound producing assembly including
a vibrating member having a diaphragm part disposed in front of said magnetically permeable plate and a coil bobbin connected to said diaphragm part and extending into said air gap, said diaphragm part and said magnetically permeable plate defining a chamber in fluid communication with said air passageway and said air gap, and
a voice coil connected to said coil bobbin.

2. The loudspeaker device as claimed in claim 1, wherein said frame assembly further includes a front cover member disposed in front of said vibrating member and connected to said rear frame member.

3. The loudspeaker device as claimed in claim 2, wherein:
said rear frame member has a front end surface that defines an opening for access into said receiving space;
said vibrating member further includes a suspension part extending outwardly and radially from said diaphragm part;
said sound producing assembly further includes an insulator ring disposed in front of said front end surface of said rear frame member and disposed behind said suspension part of said vibrating member; and
said frame assembly further includes a plurality of fastener units that fasten separably said front cover member, said suspension part of said vibrating member, said insulator ring, and said rear frame member.

4. The loudspeaker device as claimed in claim 3, wherein each of said fastener units includes: a screw passing through said front cover member, said suspension part of said vibrating member, and said insulator ring and engaging threadedly said rear frame member; and a waterproof gasket sleeved on said screw and retained between said screw and said front cover member.

5. The loudspeaker device as claimed in claim 3, wherein said sound producing assembly further includes a washer disposed between said insulator ring and said front end surface of said rear frame member, said fastener units passing through said washer.

6. The loudspeaker device as claimed in claim 1, wherein said connecting tube is made of copper and rivets together said base wall, said magnet and said magnetically permeable plate.

7. The loudspeaker device as claimed in claim 1, wherein said rear frame member is made of a heat-dissipating material and includes a base portion,
said base portion including an end wall and a peripheral wall extending forwardly from said end wall and cooperating therewith so as to form said receiving space,
said end wall having an inner surface confronting said receiving space, said inner surface being formed with a first groove that is registered with said air passageway, and at least one second groove that extends from said first groove toward said peripheral wall and that is in fluid communication with said receiving space.

8. The loudspeaker device as claimed in claim 7, wherein said rear frame member further includes an outer frame portion extending outwardly from said peripheral wall of said base portion,
said loudspeaker device further comprising an enclosure disposed to cover said front cover member and connected separably to said outer frame portion of said rear frame member.

9. The loudspeaker device as claimed in claim 1, wherein said magnetic assembly further includes a filter screen disposed at a rear side of said base wall and registered with said connecting tube.

10. The loudspeaker device as claimed in claim 2, wherein said front cover member includes:
a cover body connected to said rear frame member and formed with a sound hole that extends in a front-to-rear direction; and
an equalizer connected to said cover body and disposed adjacent to said diaphragm part and said sound hole.

11. The loudspeaker device as claimed in claim 2, wherein said rear frame member is made of a heat-dissipating material and includes a base portion,
said base portion including an end wall and a peripheral wall extending forwardly from said end wall and cooperating therewith so as to form said receiving space,
said frame assembly further including a waterproofing ring disposed between said peripheral wall of said base portion and said front cover member.
